(19) United States
(12) Patent Application Publication
(10) Pub. No.: US 2011/0001052 A1
(43) Pub. Date: Jan. 6, 2011

(54) COMPUTED RADIOGRAPHY SYSTEM

(76) Inventor: Luc Struye, Mortsel (BE)

Correspondence Address: NEXSEN PRUET, LLC, P.O. BOX 10648, GREENVILLE, SC, 29603, US

(21) Appl. No.: 11/937,785

(22) Filed: Nov. 9, 2007

Related U.S. Application Data
(60) Provisional application No. 60/872,728, filed on Dec. 4, 2006.

(51) Int. Cl. G01T 1/208

(52) U.S. Cl. 250/369

(57) ABSTRACT

A computed radiography system comprises a radiation detecting system wherein an image is formed by the steps of (1) exposing an object to radiation; (2) forming a first digitized image directly captured from said radiation by a detector; (3) storing said digitized image from said radiation on an intermediate medium; (4) forming a latent image originating from the same radiation, as an image stored in a photostimulable phosphor layer, and (5) retrieving said directly captured digitized image and superposing it onto a digitized image originating from said latent image in said photostimulable phosphor layer after photostimulation of said phosphor layer with radiation having a lower energy than the said exposure radiation.

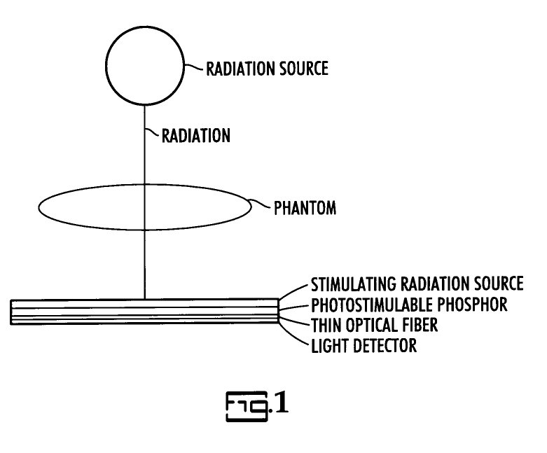

### CROSS-REFERENCE TO RELATED PATENT APPLICATIONS

This application claims the benefit of U.S. Provisional Application No. 60/872,728 filed Dec. 4, 2006, which is incorporated by reference.

### FIELD OF THE INVENTION

The present invention relates to a solution for processing computed radiographic signals in order to obtain an image having a better signal to noise ratio. More specifically the invention is related to the use of photostimulable phosphor screens in a system providing improved read-out with an increased DQE and allowing a lower exposure dose.

### BACKGROUND OF THE INVENTION

All of the patent and literature references hereinafter are incorporated herein by reference.

A well-known use of phosphors is in the production of X-ray images. In a conventional radiographic system an X-ray radiograph is obtained by X-rays transmitted image-wise through an object and converted into light of corresponding intensity in a so-called intensifying screen (X-ray conversion screen) wherein phosphor particles absorb the transmitted X-rays and convert them into visible light and/or ultraviolet radiation to which a photographic film is more sensitive than to the direct impact of X-rays.

According to another method of recording and reproducing an X-ray pattern as disclosed e.g. in U.S. Pat. No. 3,859,527 a special type of phosphor is used, known as a photostimulable phosphor, which being incorporated in a panel, is exposed to an incident pattern-wise modulated X-ray beam and as a result thereof temporarily stores energy contained in the X-ray radiation pattern. At some interval after exposure, a beam of visible or infra-red light scans the panel to stimulate the release of stored energy as light that is detected and converted to sequential electrical signals which can be processed to produce a visible image. For this purpose, the phosphor should store as much as possible of the incident X-ray energy and emit as little as possible of the stored energy until being stimulated by the scanning beam. Upon stimulation with relatively long wavelength stimulating radiation such as red or infrared light produced e.g. by a helium neon gas laser or diode laser, the storage phosphor thus releases emitted radiation of an intermediate wave-length, such as blue light, in proportion to the quantity of X-rays that were received. In order to produce a signal useful in electronic image processing the storage phosphor is scanned in a raster pattern by a laser beam deflected by an oscillating or rotating scanning mirror or hologon, a so-called “flying spot”, or is scanned with a linear array of e.g. LED's. The emitted radiation from the storage phosphor is reflected by a mirror light collector or guided by means of fiber optics in order to become detected by a photodetector such as a photomultiplier in order to produce an electronic image signal. Typically the storage phosphor is translated in a page scan direction past the laser beam which is repeatedly deflected in a line scan direction perpendicular to the page scan motion of the storage phosphor to form a scanning raster patter of a matrix of pixels. This imaging technique is called “digital radiography” or “computed radiography”. The first digital X-ray systems, known as computed radiography (CR) have thus been known to make use of a stored energy releasing phosphor sheet which is exposed to a radiation image during X-ray exposure and stores the radiation image at exposure whereafter the stored energy image is read out using stimulating radiation scanning the phosphor plate, releasing the image-wise stored energy as light, wherein the light is detected and an electronic image is generated by the light detector and processing electronics, whereafter it is digitized. In practical applications of e.g. medical imaging in order to get a diagnostic image, the stimulable phosphor stores part of radiation energy when exposed to radiation, and exhibits photostimulated luminescence (PSL) according to the stored energy when exposed to stimulating light, such as e.g. visible light. The radiation image diagnostic information from a human body, temporarily recorded on a stimulable phosphor sheet is scanned with a stimulating light beam such as a laser beam, and is caused be emitted as photostimulated luminescence light. Said photostimulated luminescence light becomes photoelec-trically detected and converted to an image signal carrying the radiation image information. As image information reading apparatuses, a wide variety varying in manner of scanning and in the form of the photoelectric conversion means have been proposed.

Photo-stimulated luminescence, generated from the storage phosphor by the excitation light, is converged and converted into an electric signal by means of a photo-electric conversion device such as e.g. photomultiplier. A photomultiplier as a photoelectric converter has a high sensitivity to the wavelength of photostimulated luminescence light ranging from about 300 to 500 nm (i.e. in the blue light wavelength range) and a low sensitivity to the wavelength of stimulating light ranging from about 600 to 700 nm (i.e. in the red light wavelength range). The photomultiplier amplifies a micro-signal resulting from feeble photostimulated luminescence light, by the external photoelectric effect so that it is not influenced by electrical noise. Besides its low shock resistance and cost, the quantum efficiency of the photocathode utilizing external photoelectric effect is low: with respect to photostimulated luminescence light in blue wavelength range it is normally as low as about 10 to 20%, whereas the quantum efficiency with respect to photostimulated luminescence light in the red wavelength range is normally about 0.1 to 2%, so that a stimulating light cut filter becomes necessary in order to obtain a satisfactory signal-to-noise ratio (S/N), which means a further increase in manufacturing cost.

In “Radiographic Process Utilizing a Photoconductive Solid-State Imager (772/Research disclosure, October, 1992/34264) a system is disclosed, which is provided with a radiation-image converting panel as one form of the photoelectric conversion means, more particularly as a zero-dimensional photoelectric converter. The radiation-image converting panel is constructed of an image recording sheet having a stimulable phosphor layer which emits photostimulated luminescence light by an amount corresponding to energy stored when irradiated with stimulating light, and a photoconductive layer (interposed between two electrode layers) having a sensitivity to the photostimulated luminescence light. The image recorded on the radiation-image converting panel is read by scanning the panel two-dimensionally with a light spot. It is disclosed that for the photoconductive layer constituting the panel, a layer having a high sensitivity to a photostimulated luminescence light wavelength of 500 nm and a low sensitivity to a stimulating light wavelength of 633 nm is satisfactory and that amorphous selenium (α-Se) is preferred, the more as it is high in shock resistance. Since the area of the photoconductive layer becomes larger, the generation of excessive dark current cannot be avoided, and since capacitance (output capacitance of the detector) also becomes greater, only an image with a poor S/N ratio may be obtained. Even if each electrode is divided, the area of the photoconductive layer will remain approximately the same area as the sheet and the cost will be increased. Because the total area of the electrodes remains large, the generation of excessive dark current cannot be avoided, and as capacitance is also great, the problem of a poor S/N ratio remains. A solution has been proposed in US-Application 2001/0020690 by a method of reading image information, comprising the steps of using an image recording sheet which has a stimulable phosphor layer that emits photostimulated luminescence light of a quantity corresponding to energy stored when irradiated with stimulating light, and a solid-state image detector which has a photoconductive layer that exhibits conductibility when irradiated with said photostimulated luminescence light; scanning said image recording sheet carrying said image information recorded thereon with said stimulating light; guiding photostimulated luminescence light obtained by said scanning so that said photostimulated luminescence light is incident on said photoconductive layer; detecting electric charge generated in said photoconductive layer by the incidence of said photostimulated luminescence light, under an electric field applied across said photoconductive layer; and obtaining an image signal which carries said image information by detecting said electric charge; wherein the stimulable phosphor layer of said image recording sheet is simulated with said stimulating light having a wavelength of 600 nm or greater and emits said photostimulated luminescence light having a wavelength of 500 nm or less; the photoconductive layer of said solid-state image detector contains amorphous selenium as its main component and also has a smaller area than that of said image recording sheet; and said scanning is performed by moving said solid-state image detector relative to said image recording sheet on the surface thereof.

More recently, an X-ray image reading system having a semiconductor detecting means for directly converting X-ray photons into an electric signal has been developed. In this type of X-ray image reading system, being different from the X-ray image reading system using the storage phosphor, it is not necessary to irradiate an excitation light source such as laser light beams for reading the X-ray image information. Thereby a blur does not occur due to scattering or diffusion of the excitation light, and an X-ray image with a very high sharpness can be obtained. Further, a scanning system and an optical reading system of the excitation light, a mechanical conveying system, and an erasing system of remaining image are not necessary. Accordingly, in the X-ray image reading system having the semiconductor detecting means, a very sharp X-ray image can be obtained as compared with the X-ray image reading system using the storage phosphor, as well as the reduction of the size and weight of the X-ray photographic system can be achieved. In such a system it is known however that image graininess is deteriorated as sharpness is increased: in the low density area the quantity of X-rays reaching the detector is small and graininess is worse due to quantum noises as compared to that in the high density area in which a quantity of X-rays reaching the detector is large. A solution has been proposed therefor in US-Application 2002/0079457 wherein a radiation image reading method in which the graininess is improved in the low density area of the radiation image, while the sharpness is maintained in the high density area thereof. Such a radiation image reading apparatus comprises a semiconductor detector for converting radiation photons penetrated through a subject into electric signals to generate a first radiation image information; and a processor for processing said first radiation image information, so that a modulation transfer function in a low density region is not higher than a modulation transfer function in a high density region, in order to generate a second radiation image information. Said semiconductor detector converting radiation photons into electric signals by receiving radiation photons at all of the pixels comprises, besides a substrate, a plurality of electrodes fabricated at all of the pixels in order to receive radiation photons according to the radiation image information of a subject in each pixel unit; capacitors fabricated at all of said electrodes in order to store electric charges generated by receiving said radiation photons in each of said electrodes; switching elements, such as transistors in order to control a reading action of said electric charges stored in said capacitors;

a photoconductive layer fabricated in order to cover said switching elements, said capacitors and said electrodes; and a surface electrode fabricated in order to cover said photoconductive layer, in order to serve as a common electrode, wherein electron-hole pairs, which are generated in said photoconductive layer by said radiation photons penetrated through said subject, are separated by an electric field with a predetermined potential applied between said surface electrode and said substrate electrode, and then said switching elements read and control said electric charges stored in said capacitors by said electric field. As a result in one embodiment thereof said low density region is a low density region in information based on said first radiation image information, and said high density region is a high density region in information based on said first radiation image information. In another embodiment said processor processes said first radiation image information, so that said modulation transfer function in said low density region is lower than said modulation transfer function in said high density region, in order to generate a second radiation image information.

In US-Application 2004/0200971 a radiographic image is obtained by combining at least two radiographic sub-images acquired by at least an upper and lower 2-dimensional radiation sensor having sensor pixels. The radiation sensitive area of the lower sensor is overlapped by the upper sensor and overlap is preferably at least two pixel rows, but may also be limited to non-imaging parts of the upper sensor. The radiation sensors may comprise a radiation to light converting layer and preferably the sensors are built using CMOS technology, exhibiting less radiation absorption outside the radiation sensitive area.

Besides systems making use of photostimulable or storage phosphor panels, direct digital X-ray systems (DR systems) for reading out the radiation image in real time, make use of electronic sensors. As has been taught in US-Application 2004/0200971 the systems can be divided in two main classes:

1. Systems making use of direct X-ray conversion to electrons, wherein the incident radiation reaches a photoconductor material which transforms the radiation into electron-hole pairs in response to the intensity of the X-rays, wherein charges generated are collected in a silicon based chip supporting the photoconductor and wherein conversion materials typically make use of e.g. amorphous Selenium, Mo, lead iodide, mercury iodide, CdTe and CdZnTe.

2. Systems making use of indirect conversion sensors having a scintillator or phosphor layer as conversion layer converting the X-rays into visible light which is then detected with an electronic light sensor array which converts the light into electrons.

Materials used in the conversion layer are e.g. gadolinium oxysulfide or cesium iodide. It is essential that the conversion layer absorbs a significant part of the X-rays in order to achieve efficient detection and the lowest possible dose to the patient. Well-designed electronic system should typically reach double efficiency versus classical film-based X-ray detection.

The majority of the current systems are flat panels made with amorphous silicon technology. These are matrix arrays of a-Si addressing transistors covered with a photoconductor material in case of type 1, whereas in type 2, these are matrix arrays of a-Si addressing transistors and a-Si photodiodes, covered with a phosphor.

Disadvantages however are related with

1. Pixel resolution which is currently limited, as amorphous silicon, due to its physical properties, does hardly allow to fabricate pixels smaller than some square 100 μm.

2. Panels being of the passive type, i.e. having no “in-pixel amplification” capability, which makes fast imaging, i.e. continuously producing more than 1 image per second, very cumbersome and expensive.

In principle, a detector making use of crystalline Si or another high-quality semiconductor material would be far superior in terms of attainable smaller pixel size, due to the possibility of in-pixel circuitry such as amplifiers which greatly helps for higher imaging speeds. The major problem encountered, is that the (silicon) wafers used in the manufacturing of such detectors are limited in size, that large wafers are very costly and also that the yield of the production process may be low, in that the percentage of good sensors out of a production run decreases very rapidly with increasing size. An existing solution to this problem is that the light image generated by the conversion layer is reduced and imaged to the small image sensor by an optical system, making use of crystalline detectors such as CCD or CMOS sensors for indirect detection. This may be performed in a lens system or in an optical fibre system.

The most important drawbacks of this method are that, due to the reduction of the image, a relatively low number of pixels are read out for a large image, resulting in an inferior image quality, due to lower resolution. A significant portion of the light is lost, leading to lower detection efficiency and/or higher dose to the patient. This happens because with the current state of the technology, and with demagnifications higher than five to ten times, unless expensive cooling mechanisms are used, the electronic noise from the detector system will be so high in comparison with the electronic signal, that the intrinsic signal-to-noise ratio of the X-ray signal is significantly degraded. Bulky optics do not allow that the readout system is housed inside e.g. a conventional X-ray cassette as would be desirable in that a system which can be housed in a cassette with the form factor of a conventional X-ray cassette could then be plugged into a conventional X-ray apparatus. This would allow an easy upgrade from analog to digital imaging workflow, whereby the existing X-ray apparatus does not need to be entirely replaced. Standard cassettes are provided in several sizes for different applications and dimensions and specifications of cassettes are regulated by international approved standards such as ANSI IT 1.49. In order to avoid undesirable low number of pixels mentioned above, systems have been sought to split up the large field of view into smaller sections, each covered by a separate imager. The method for doing this should however not show any visible grayscale response or differences between individual image sensors, usually solved with proper calibration techniques; and not lose any image information in between the image sensors.

Several prior art systems making one large image therefore use multiple image sensors wherein techniques try to minimize or even eliminate the spacing between the border pixels of the individual imagers by bringing them close together, a phenomenon called “butting”. Linear butting of sensors can be found in several documents as in U.S. Pat. No. 4,755,681 wherein an image-receiving plane is made up of a two-dimensional array of radiation detectors, each having its own image processing circuit, but wherein in between the sensors insensitive gaps exist;
in U.S. Pat. No. 6,207,944 wherein a sensor is provided in which the edge pixels are larger in order to provide butting of the different sensors, but wherein providing a larger edge pixel generates a distortion to the image at the location of the butting lines. Likewise in U.S. Pat. No. 6,323,475 conductive tracks lead from the selected detector positions to offset readout circuit positions allowing for certain pixels to be bigger than others. In U.S. Pat. No. 6,403,964 several imaging device tiles are very accurately mounted on a support structure. Especially the very accurate mounting poses problems in fabrication and makes such a combination of imaging tiles costly. It requires high-precision machining technology to cut the silicon very precisely, and high precision machinery is needed to mount the chips together, which makes it costly and complex. In US-Applications 2001/0012412 and 2002/0006236 sensors are mounted to but sensitive areas: in one direction the chips overlie each other while in the other direction the chips are butted, but typically the edges of chips can not be brought close together than 50-100 μm, leaving a gap in between that is not light-sensitive and thus could miss essential diagnostic information. Other systems making use of overlap of sensors in one direction in order to bring pixels closer together and not to loose information, are found in EP-A 0 421 869, wherein a very accurate overlapping of the chips provides butting of the sensitive areas. In U.S. Pat. No. 4,467,342 CCD chips for detecting radiant energy have an overlap joint without substantial phase difference occurring at the lap joint, but aligning the sensors accurately is a major difficulty. CCD sensors further exhibit low efficiency for radiation image sensing. Another approach is to make use of multiple cameras providing overlapping images of e.g. a scintillator screen. In U.S. Pat. Nos. 4,503,460 and 5,881,163 a combination of plural television pickup devices coupled to one X-ray intensifier using optics is used, wherein various detected regions overlap. The system has the drawback that, due to the use of lenses, the apparatus is large and can not be retrofitted in existing machines and X-ray cassettes. Although these systems have the advantage that no information is missing in between the separate images, such systems however also have a lower light efficiency, and apart for the cost of the multiple systems, these systems usually do not fit in a conventional film-based X-ray system due to their thickness. U.S. Pat. No. 6,038,286 makes use of mirrors in order to divide the image towards several camera systems, but although its height is somewhat less, that system has nearly the same drawbacks as it uses multiple cameras and overlap seam problems may occur at mirror edges. U.S. Pat. Nos. 4,905,265; 5,043,582; 5,220,170; 5,381,013; 5,440,130 and 5,464,984; WO 91/10921 are related with the use of the transparency of silicon when using DRAM Chips having large spaces between cells as imaging sensors. However large spaces in between cells are not acceptable for medical applications. Other systems make use of mechanical step and repeat systems successively positioning the sensors at different positions. Mechanical systems are however slow, expensive and pose on the long term reliability problems. Summarized it can be concluded that the current state of the art is so that imagers are either butted and in such case there is always a compromise on the image detail at the seams, while positioning is cumbersome and expensive; or a camera-like approach is used, but in such case the detector assembly rapidly becomes too thick to allow insertion into conventional analog X-ray units.
The need for a digital X-ray detection system combining several desired properties having a relatively large sensing area with sufficient pixel density having low enough noise to produce more than one image per second, being flat enough to allow insertion in conventional X-ray units, not missing of significantly compromising parts of the image due to imperfect butting of the different imagers the detector plane is composed off, and allowing at the same time low-cost manufacturing techniques for positioning the different imagers has been recognized in US-Application 2004/0200971, wherein as a solution a method for obtaining a radiographic image comprises the steps of acquiring at least two radiographic sub-images during a single radiographic exposure from a radiation source; using at least an upper and a lower two-dimensional radiation sensor relative to the direction of the radiation source, the sensors each having a radiation sensitive area comprising pixels; combining the acquired radiographic sub-images to obtain a combined radiographic image, wherein the two two-dimensional radiation sensors overlap each other, whereby the radiation sensitive part of the lower sensor is overlapped by the upper radiation sensor in the direction of the radiation source. Use is made therein of the principle that for most X-ray diagnostic energies, semiconductor materials used in electronics are materials as crystalline and amorphous Si and Ge, GaAs, Se and CdSe, without however being limited thereto, which provide partial transparency to the radiation at wafer thickness used in electronics, due to their low atomic weight. Moreover these materials also hardly scatter radiation and thus avoid blurring.

### SUMMARY OF THE INVENTION

It is an object of the present invention to provide a simple, cost-effective diagnostic read-out system in medical imaging, wherein a lower radiation exposure dose is required in favor of the safety of the patient and wherein an image having a better signal to noise ratio is obtained.

The above mentioned objects are realized by a computed radiography system having the specific features defined in claim 1. Specific features for preferred embodiments of the invention are set out in the dependent claims.

Further advantages and embodiments of the present invention will become apparent from the following description [and drawing].

### BRIEF DESCRIPTION OF THE DRAWINGS

The FIGURE shows a particular embodiment in the system wherein a phantom is exposed to X-rays and wherein non-absorbed radiation is captured by a detector, provided with, in consecutive order and positioned from more close to a position farther from the exposure source: a stimulating radiation source, a photostimulable phosphor layer, a thin optical filter layer and a light detector.

### DETAILED DESCRIPTION OF THE INVENTION

According to the present invention a computed radiography system comprises a radiation detecting system wherein an image is formed by the steps of

(1) exposing an object to radiation;

(2) forming a first digitized image directly captured from said radiation by a detector;

(3) storing said digitized image from said radiation on an intermediate medium;

(4) forming a latent image originating from the same radiation, as an image stored in a photostimulable phosphor layer, and

(5) retrieving said directly captured digitized image and superposing it onto a digitized image originating from said latent image in said photostimulable phosphor layer after photostimulation of said phosphor layer with radiation having a lower energy than the said exposure radiation.

Whereas the steps (2) and (4) take almost place on the radiation detector within the same time range or interval, immediately after radiation exposure step (1), the steps (3) and (5) are following and may be performed with some delay.

In the system according to the present invention said radiation detector comprises

(1) a first element responsive to said radiation and directly converting said radiation into electrical signals when being captured by said first element;

(2) a second element responsive to said radiation, storing said radiation as a latent image in said second element and emitting stored energy by a stimulating radiation source in order to release said stored energy and to convert it into an electrical signals, wherein said electrical signals are represented in digitized form and superposed in order to form one digital image generated from signals originating from both elements.

In the system according to the present invention said intermediate medium stores electrical signals, generated by direct conversion of said radiation by said first element in said detector. In a more particular embodiment said intermediate medium is selected from the group consisting of an internal or external hard disc, a CD-ROM, a DVD, an internal memory of a personal computer, a tape, a memory stick and a memory card.

Further in the system according to the present invention said radiation is selected from the group consisting of X-, α-, β-, γ-rays, electrons and neutrons. More particularly, in the system according to the present invention said radiation exposure is an X-ray exposure.

In the system according to the present invention said first element directly converts said radiation captured by said first element into an electrical signal. More particularly said first element is selected from the group consisting of a CCD, a CMOS, a photoconductive layer and an array of photomultipliers. A CCD in form of an array of charge coupled device elements acting as an array of transducer elements converting the said detected light emitted upon stimulation into an electrical signal representation is advantageously applied.

Photomultipliers may be used in the method of the present invention, taking into account that the sensitivity of a PMT, i.e. magnitude of output signal to input luminous energy, used in a radiation image recording/reading system is determined by the magnitude of the high voltage applied to the PMT. Each PMT of the same type, however, has its own characteristics which are different with each other. Thus, the voltage required for obtaining an intended sensitivity differs from PMT to PMT. Consequently, the high voltage is properly adjusted for each system in order to obtain an intended sensitivity which changes as it is used, and use can advantageously been made from the measures disclosed in US-Application 2006/0054846. As disclosed therein in a method for estimating sensitivity change in a photomultiplier used in a radiation image reading unit in which a radiation image recorded on a storage phosphor sheet through the exposure of the radiation carrying the image is read out by irradiating excitation light on the storage phosphor sheet to produce stimulated luminescence light, and obtaining image signals that correspond to the radiation image through photoelectrical detection of the stimulated luminescence light emitted from the storage phosphor sheet using the photomultiplier, wherein information indicates the sensitivity change in the photomultiplier, is obtained by the steps of: obtaining exposure conditions which were set when the radiation image was recorded on the storage phosphor sheet; calculating an estimated amount of radiation irradiated on the storage phosphor sheet based on the exposure conditions obtained; cumulatively adding the estimated amount of radiation for each radiation image read out by the radiation image reading unit; and obtaining the cumulative value of the estimated amounts as the information that indicates the sensitivity change in the photomultiplier. Another embodiment wherein calculating an estimated amount of radiation irradiated on the storage phosphor sheet based on the image signals detected by the photomultiplier; cumulatively adding the estimated amount of radiation for each radiation image read out by the radiation image reading unit; and obtaining the cumulative value of the estimated amounts as the information that indicates the sensitivity change in the photomultiplier, may be applied. Lowering of the sensitivity of a photomultiplier due to use of the photomultiplier is capable of being detected accurately when used in the method of the present invention, by measures as set forth in US-Application 2006/0054845.

Information-bearing light subsequently focused onto an information receiving target, such as a charge-coupled device (CCD) e.g. disclosed in US-Application 2005/0061999, may be applied in the method of the present invention. Just as in US-Application 2004/0061061, in the present invention a radiation image read-out apparatus may be provided with a line sensor which detects stimulated emission emitted from a radiation image convertor panel upon exposure to a line-like stimulating light beam extending in a main scanning direction and reads out a radiation image recorded on the radiation image convertor panel while moving the line sensor and the radiation image convertor panel relatively to each other in a sub-scanning direction intersecting the main scanning direction. The line sensor may include a CCD having a number of light receiving portions two-dimensionally arranged along the main scanning direction and puts out electric charges obtained by photoelectrically converting the stimulated emission received by the light receiving portions after binning the electric charges in a direction perpendicular to the main scanning direction. The line sensor may be provided with a microlens array extending in a direction perpendicular to the main scanning direction in front thereof. Said microlens array may be provided over an area including the light receiving portions and the charge transfer paths of the CCD.

Just as in US-Applications 2005/0058247 and 2005/0084065 wherein it is an object to provide an X-ray analysis apparatus which can form a two-dimensional diffraction image in a fast way with a high accuracy, a two-dimensional CCD sensor may be used in the method of the present invention, together with scan-moving means for scan-moving the two-dimensional CCD sensor in a plane. Charge-transfer signal generating means for generating a charge-transfer signal in the CCD sensor may be applied, every time the CCD sensor is moved for a distance corresponding to the width of a pixel constituting the CCD sensor. Motion of the semiconductor X-ray detecting means and generation of the charge-transfer signal are synchronized with each other in order to achieve time delay integration operation. Since the timing of transfer of electric charges in the CCD sensor is synchronized with scan-motion velocity of the CCD sensor, each pixel can accurately analyze the intensity of the X-rays.

Although not being suitable over the entire range of applications, many digital X-ray systems currently in use and under development may be used in the method of the present invention. Some of them based upon charge-coupled device (CCD) technology, others based upon thin-film-transistor (TFT) technology as a technology making use of one or more photoconductive layers, are comparable to film in performance. An attempt to provide a method for controlling the dynamic range and signal-to-noise ratio of a digital X-ray system so that a single device may be used over a wide range of applications and energy levels, and more in particularly, with respect to TFT-based digital X-ray systems, may be applied in the method of the present invention as has been described in US-Application 2002/0195566. Therein a method comprises varying the voltage between the top electrode layer and the TFT readout matrix to provide an acceptable signal-to-noise ratio over a greater range of exposures than provided at a single voltage. Such a method may be applied as providing high contrast images and even includes providing a signal-to-noise ratio of at least about 50, more particularly when reducing scatter radiation.

As in US-Application 2002/0079457 a reading system may be applied wherein a semiconductor detecting means for converting radiation photons penetrated through the subject into an electric signal is provided. When the radiation image of the subject is reproduced as a visual image, an image signal obtained from the semiconductor detecting means is processed so that the graininess is further improved in the low density area of the radiation image, while the sharpness is maintained in the high density area.

Further in the computed radiography system according to the present invention said second element emits energy stored in said element by photostimulation. More particularly said photostimulation proceeds by a radiation source in the wavelength range from 450 nm to 800 nm.

In the system according to the present invention photostimulation advantageously proceeds by a radiation source selected from the group consisting of a laser source, a linear array of laser diodes, a short arc lamp, an electroluminescent screen, a set of LED's and a lamp provided with optical filters. More particularly said optical filters stand for filters having a dye layer as disclosed in US-Applications 2006/0030738 and 2006/0027770, i.e., at least one organo transition metal dye, or, as a particular type thereof, a phthalocyanine, more particularly, Cu-phthalocyanine as described and used in U.S. Pat. Nos. 6,967,339; 6,977,385 and 7,026,632; and in US-Application 2004/0094729, and even more particularly sulphonated Cu-phthalocyanine.

In the particular embodiment wherein use is made of a laser source, said laser source is selected from the group consisting of HeNe, Argon-ion, Nd-YAG, Nd-YLF and a diode laser.

In the radiation detector used in the computed radiography system according to the present invention, said first and said second element are in close contact, adjacent to each other.

In another embodiment thereof, in said radiation detector, said first and said second element are separated by a thin optical filter between each other as illustrated in the FIGURE. More particularly in the system according to the present invention said optical filter layer provides high transmission of light in the blue wavelength range and high absorption in the red wavelength range.

In an even more particular embodiment in the system according to the present invention said optical filter layer comprises a dye layer, wherein said dye has a ratio of transmission at the stimulating emission wavelength of a source of stimulation light and transmission of stimulated light in the wavelength range between 350 nm and 500 nm is less than 10⁻⁶, wherein said ratio is defined by the formula Tr(λₛₜ)/Tr(λₓ)<10⁻⁶ wherein λₛₜ is the stimulation wavelength, expressed in nm, and wherein 350 nm<λₓ<500 nm, as disclosed in US-Applications 2006/0030738 and 2006/0027770.

Just as in these Applications at least one organo transition metal dye is advantageously used, and more particularly, a sulphonated Cu-phthalocyanine as mentioned hereinbefore.

Moreover in the computed radiography system according to the present invention said photostimulable phosphor layer said photostimulable phosphor is a BaFBr:Eu or a CsBr:Eu type phosphor. More particularly CsBr doped with divalent Eu has been shown to be a promising X-ray storage phosphor which can be grown in form of needle-shaped crystals. In basic U.S. Pat. No. 6,802,991 a specific method is offered for producing such a phosphor by vapor deposition in a vapor deposition apparatus by heating a mixture of CsBr with an Europium compound selected from the group consisting of e.g. EuBr₂, EuBr₃ and EuOBr, by heating said mixture at a temperature above 450° C., and depositing said phosphor on a substrate by a method selected from the group consisting of physical vapor deposition, chemical vapor deposition or an atomization technique.

In U.S. Pat. No. 6,730,243 a method for preparing a CsBr:Eu phosphor comprises the steps of mixing or combining CsBr with between 10⁻³ mol % and 5 mol % of a europium compound wherein said europium compound is a member selected from the group consisting of EuBr₂, EuBr₃ and EuOBr; vapor depositing that mixture onto a substrate; forming a binderless phosphor screen; cooling said phosphor screen to room temperature, bringing said phosphor screen to a temperature between 80 and 220° C. and maintaining it at that temperature for between 10 minutes and 15 hours, i.e. an annealing step is added in order to further correct, i.e. increase phosphor speed. In the method according to the present invention, the CsBr:Eu phosphor used is advantageously prepared by mixing CsBr as an alkali metal halide salt and wherein as a lanthanide dopant salt use is made of EuX₂, EuX₃, EuOX or EuX_{z}, wherein 2<z<3 and wherein X is one of Br, Cl or a combination thereof. In another embodiment said CsBr:Eu phosphor is advantageously prepared by mixing CsBr as an alkali metal halide salt and wherein between 10⁻³ and 5 mol % of a Europium compound selected from the group consisting of EuX₂, EuX₃, EuOX, or EuX_{z}, wherein 2<z<3 and wherein X is one of Br, Cl or a combination thereof, firing the mixture at a temperature above 450° C., cooling said mixture, and recovering the CsBr:Eu phosphor. In still another embodiment said CsBr:Eu phosphor is advantageously prepared by mixing CsBr as an alkali metal halide salt and a combination of an alkali metal halide salt and a lanthanide dopant salt according to the formula CsₓEu_{y}X′_{x+αy}, wherein x/y>0.25, wherein α≧2 and wherein X′ is a halide selected from the group consisting of Cl, Br and I and combinations thereof. In the method of the present invention said CsBr:Eu phosphor screen is advantageously obtained by depositing said phosphor on a substrate by a method selected from the group consisting of physical vapor deposition, thermal vapor deposition, chemical vapor deposition, radio frequency deposition and pulsed laser deposition. As taught in U.S. Pat. No. 7,126,135 further corrections can be made by a radiation exposure treatment during or after at least one of the preparation steps with energy from radiation sources emitting short ultraviolet radiation in the range from 150 nm to 300 nm with an energy of at least 10 mJ/mm².

As after photostimulation a “ghost image” may in part be still present as not all stored information is read out, erasure techniques may be suitable to be applied in the method of the present invention in order to erase storage phosphor screens or panels coated with a binderless needle-shaped vapor deposited CsBr:Eu phosphor after use as described in U.S. Pat. Nos. 6,504,169; 6,528,812 and 6,512,240. So the method described in U.S. Pat. No. 6,504,169 may be applied, wherein in a method of reading of a radiation image that has been stored in a photostimulable phosphor screen having a surface area that is not greater than Sₘₐₓ the steps are comprised of (1) stimulating said phosphor screen by means of stimulating radiation, (2) detecting light emitted by the phosphor screen upon stimulation and converting the detected light into a signal representation of said radiation image, (3) erasing said phosphor screen by exposing it to erasing light, wherein (4) said photostimulable phosphor screen comprises a divalent europium activated cesium halide phosphor and wherein (5) said erasing light is emitted by an erasing light source assembly emitting in the wavelength range of 300 nm to 1500 nm and having an electrical erasing energy not greater than Sₘₐₓ×1 J, and wherein said wavelength is in the range between 500 nm and 800 nm. Otherwise, as in U.S. Pat. No. 6,528,812 a re-usable radiation detector may be applied, comprising a photostimulable phosphor screen, at least one source of stimulating light arranged for stimulating said phosphor screen, an array of transducer elements arranged for capturing light emitted by the phosphor screen upon stimulation and for converting said light into an electrical signal representation, an erasing unit comprising an electroluminescent lamp arranged in order to illuminate said phosphor screen when being energized, means for transporting an assembly comprising the at least one stimulating light source, the erasing unit, and the array of transducer elements relative to the phosphor screen, an enclosure enclosing said photostimulable phosphor screen, the assembly comprising the at least one stimulating light source, the erasing unit, and the array of transducer elements, and the means for transporting said assembly, interfacing means for communicating said electrical signal representation to an external signal processing device. Said electroluminescent lamp is based therein on an inorganic or organic electroluminescent phosphor. As in the embodiment disclosed in U.S. Pat. No. 6,512,240 a method of reading a radiation image may be applied that has been stored in a photostimulable phosphor screen, wherein said method comprises the steps of (1) stimulating said phosphor screen by means of stimulating radiation emitted by a stimulating light source, (2) detecting light emitted by the phosphor screen upon stimulation and converting the detected light into a signal representation of said radiation image, (3) erasing said phosphor screen by exposing it to erasing light, wherein (4) said photostimulable phosphor screen comprises a divalent europium activated cesium halide phosphor and wherein (5) said erasing light is emitted by an erasing light source assembly comprising at least one laser. It has further been claimed therein that said stimulating light source is the same light source as said erasing light source.

The stimulation spectrum of a CsBr:Eu phosphor, showing the possible wavelengths, suitable for use in order to stimulate the phosphor is known to show only one peak in the spectrum in the range from 550 nm to 850 nm with a maximum at 700 nm. Hitherto only these wavelengths have been used so far that provide ability to stimulate this type of phosphor. It has further been established that the stored energy is also thermally stimulable at room temperature and that thereby the phosphor is weakly emitting radiation, even when it has not been stimulated with light. The light emitted as a consequence of thermal stimulation, however creates noise, so that the image quality gets worse. The more thermally stimulated emission, the stronger or more intense the “afterglow” and the more a negative influence on image quality is encountered.

In a particular embodiment, just as in US-Provisional Application having Ser. No. 60/839,379; a method providing a combination of consecutively erasing shallow traps, directly followed by readout of deep traps by scanning with one and the same laser may be applied. A particularly suitable laser therefor is e.g. a Nd:YAG laser. So a first scanning with the said laser, while blocking stimulating blue light by a filter and allowing transmittance of radiation of long wavelengths in the infrared wavelength range is advantageously followed by a direct scanning with the same laser, without a filter blocking the stimulating blue light now in order to allow stimulation of stored energy and to provide emission of energy, stored in deep energy traps, in order to provide representation of the radiation image of an X-ray exposed subject with less noise and a better image quality.

So in a device for reading information stored in a phosphor layer, as in U.S. Pat. No. 6,369,402; a transparent carrier material including the CsBr:Eu phosphor layer is provided further with a radiation source for emitting excitation or stimulating radiation; a receiver for receiving emission radiation emitted by the phosphor layer, wherein the radiation source is arranged on one side of the carrier material and the receiver is arranged on the other side of the carrier material, so that an optical path is defined between the radiation source and the receiver and at least one thin reflective layer disposed in the optical path between the radiation source and the receiver for reflecting at least a portion of the stimulating excitation radiation away from said receiver. In such a device the reflective layer is arranged between the radiation source and the phosphor layer and designed to reflect a wavelength range of the excitation radiation which is not used to excite the phosphor layer. More particularly when, as in the present invention, it is advantageous to have two reflective layers, in that the first reflective layer is arranged between the phosphor layer and the receiver and in that the second reflective layer is arranged between the radiation source and the phosphor layer and designed to reflect a wavelength range of the stimulating radiation not used to excite the phosphor layer. The device advantageously is a construction wherein the carrier material and the phosphor layer have a fixed location in the device, wherein the radiation source is arranged on a side of the carrier material facing away from the phosphor layer and the receiver is arranged on a side of the carrier material facing towards the phosphor layer and where there is a straight optical path between the radiation source and receiver; and between the phosphor layer and receiver, wherein the receiver is provided with an optical imaging means capable of capturing the emission radiation emitted by the phosphor layer and imaging the emission radiation onto the receiver. The device is further provided with imaging means comprising optical waveguides. In such a device the radiation source is a line light source for exciting an individual row of the phosphor layer and the receiver, therefor comprising a plurality of pixels for point-by-point reception of the emission radiation and wherein the emission radiation emitted by the excited row of the phosphor layer can be simultaneously received by the pixels, so that the phosphor layer can be read row by row. In the present invention it is advantageous to first excite, row by row, the shallow traps in the phosphor, i.e. that in a first scanning, line per line, the blue laser light of the NdYAG laser is blocked and/or reflected while the long infrared wavelengths are erasing the shallow traps, whereas in a second scanning, whether or not almost immediately following the first scanning, the blue laser light is transmitted and is stimulating the deep traps generated by X-ray exposure and energy storage of the latent image, which should be readout in order to represent the image-wise X-ray exposed subject.

In another embodiment a tunable laser, providing ability to change its emitted wavelength as desired, may be used in order to provide readout by energy having an optimally chosen wavelength in the stimulation spectrum in order to get a stimulated emission signal as high as possible. Whereas use of one and the same laser requires transport of the plate twice, thereby doubling the readout time, an alternative is offered by providing a readout system having two lasers, positioned adjacent to each other, so that the steps of erasure and readout immediately follow subsequently.

Scan-head type imagers differ from the conventional flying spot type in that in the scan-head type the image readout is line-wise whereas in the conventional “flying spot” type readout unit the reading is performed in a point-by-point fashion. In such an arrangement, the first reflective layer is arranged between the imaging means and the receiver. In a particular embodiment the radiation source and the receiver are connected to each other and the device further comprises a driver for providing a relative motion in a transport direction between the radiation source, the receiver and the phosphor layer. Further the device has a first reflective layer which is arranged between the imaging means and the receiver. The device wherein the radiation source and the receiver are connected to each other further comprises a driver for providing a relative motion in a transport direction between the radiation source, the receiver and the phosphor layer. In one embodiment the readout unit comprises a linear light source for emitting stimulating light onto the photostimulable phosphor screen. This linear light source comprises 4096 individual laser diodes arranged in a row. This light source provides simultaneous illumination of all pixels of a single line of the photostimulable phosphor screen. The readout unit further comprises a fiber optic plate for directing light emitted by the phosphor screen upon stimulation onto a linear array of sensor elements, i.e., more particularly charge coupled devices. The fiber optic plate comprises a number of mounted light guiding fibers arranged in parallel, in order to guide the light emitted by each individual element of an illuminated line onto a sensor element. Alternatively the fiber optic plate can be replaced by an arrangement of selfoc lenses or microlenses. A light guide member might even be avoided. In still another embodiment the array of stimulating light sources, the fiber optic plate and the sensor array are arranged at the same side of the photostimulable phosphor screen. After readout the photostimulable phosphor screen is erased so that the energy remaining in the screen after readout is released, so that the screen is in a condition for reuse. In the type of readout apparatus wherein stimulation is performed by means of light emitted by a linear light source extending parallel to a scan line on the stimulable phosphor screen, the erasure unit preferably forms part of the readout unit. An additional reflective layer for reflecting emission radiation emitted by the phosphor layer is advantageously arranged between the radiation source and the phosphor layer in order to reflect emission radiation back to the phosphor layer. In the device the reflective layer preferably has a thickness equal to one quarter of the wavelength of the excitation radiation which should be reflected by that reflective layer. In one aspect according to the method as in U.S. Provisional Application having Ser. No. 60/839,379, while erasing, use is made of at least one laser. In another aspect according to that method, while erasing, use is made of one and the same laser for all of the erasing steps and in a particular embodiment thereof said laser is a tunable laser. In a further particular embodiment the main wavelength of the said laser is mixed with one or more harmonics thereof, obtained by frequency doubling. When use is made from said one and the same laser, use is made of a longer erasing wavelength in a first erasing step and a shorter erasing wavelength in a last erasing step. Moreover while making use of said longer erasing wavelength in a first erasing step a filter is advantageously present in order to prevent transmission of said shorter erasing wavelength. Further while making use of said shorter erasing wavelength in a last erasing step, no filter is present.

In the system according to the present invention, after superposing digitized images, said image is sent to a user, as e.g. a radiologist.

As an advantageous effect of the present invention an image-forming system making use of the methods as described hereinbefore provides a better signal to noise representation of the desired image by superposition of directly and indirectly captured X-rays by one and the same detector, wherein indirectly captured X-rays require read-out by photostimulation when use is made of a photostimulable or storage phosphor plate.

### EXAMPLES

While the present invention will hereinafter be described in connection with preferred embodiments thereof, it will be understood that it is not intended to limit the invention to those embodiments.

As has been experimentally set out, while performing only one radiation exposure of the patient schematically illustrated in the FIGURE, the energy emitted by direct radiation detection on the light detector is in the same range as the energy emitted after photostimulation of the storage phosphor plate, bearing the photostimulable phosphor.

When both the direct energy captured by the first element of the detector and energy set free by photostimulation of energy stored in the photostimulable layer of the detector, present therein as a second element, are superposed, the image signal is clearly enhanced, i.e., about doubled, without an increased noise level.

As a result thereof an image having an improved signal to noise ratio has been detected. This means that, in other words, the same signal can be attained, with a lower noise level, for an exposure, decreased with a factor of 2. As a result an image having an increased DQE is obtained.

Having described in detail preferred embodiments of the current invention, it will now be apparent to those skilled in the art that numerous modifications can be made therein without departing from the scope of the invention as defined in the appending claims.

What is claimed is:

1. A computed radiography system comprising a radiation detecting system wherein an image is formed by the steps of
(1) exposing an object to radiation;
(2) forming a first digitized image directly captured from said radiation by a detector;
(3) storing said digitized image from said radiation on an intermediate medium;
(4) forming a latent image originating from the same radiation, as an image stored in a photostimulable phosphor layer, and
(5) retrieving said directly captured digitized image and superposing it onto a digitized image originating from said latent image in said photostimulable phosphor layer after photostimulation of said phosphor layer with radiation having a lower energy than the said exposure radiation.

2. System according to claim 1, wherein said radiation detector comprises (1) a first element responsive to said radiation and directly converting said radiation into electrical signals when being captured by said first element; (2) a second element responsive to said radiation, storing said radiation as a latent image in said second element and emitting stored energy by a stimulating radiation source in order to release said stored energy and to convert it into an electrical signals, wherein said electrical signals are represented in digitized form and superposed in order to form one digital image generated from signals originating from both elements.

3. System according to claim 1, wherein said intermediate medium stores electrical signals, generated by direct conversion of said radiation by said first element in said detector.

4. System according to claim 1, wherein said intermediate medium is selected from the group consisting of an internal or external hard disc, a CD-ROM, a DVD, an internal memory of a personal computer, a tape, a memory stick and a memory card.

5. System according to claim 1, wherein said radiation is selected from the group consisting of X-, α-, β-, γ-rays, electrons and neutrons.

6. System according to claim 1, wherein in said photostimulable phosphor layer said photostimulable phosphor is a BaFBr:Eu or a CsBr:Eu type phosphor.

7. System according to claim 2, wherein said first element directly converts said radiation captured by said first element into an electrical signal.

8. System according to claim 2, wherein said second element emits energy stored in said element by photostimulation.

9. System according to claim 8, wherein said photostimulation proceeds by a radiation source in the wavelength range from 450 to 800 nm.

10. System according to claim 8, wherein said photostimulation proceeds by a radiation source selected from the group consisting of a laser source, a linear array of laser diodes, a short arc lamp, an electroluminescent screen, a set of LED's and a lamp provided with optical filters.

11. System according to claim 10, wherein said optical filters stand for filters having a dye layer wherein said dye is at least one organo transition metal dye.

12. System according to claim 10, wherein said laser source is selected from the group consisting of HeNe, Argon-ion, Nd-YAG, Nd-YLF and a diode laser.

13. System according to claim 2, wherein said first element is selected from the group consisting of a CCD, a CMOS, a photoconductive layer and an array of photomultipliers.

14. System according to claim 2, wherein in said radiation detector, said first and said second element are in close contact, adjacent to each other.

15. System according to claim 2, wherein in said radiation detector, said first and said second element are separated by a thin optical filter between each other.

16. System according to claim 15, wherein said optical filter layer provides high transmission of light in the blue wavelength range and high absorption in the red wavelength range.

17. System according to claim 15, wherein said optical filter layer comprises a dye layer, wherein said dye has a ratio of transmission at the stimulating emission wavelength of a source of stimulation light and transmission of stimulated light in the wavelength range between 350 nm and 500 nm is less than 10⁻⁶, wherein said ratio is defined by the formula Tr(λₛₜ)/Tr(λₓ)<10⁻⁶ wherein λₛₜ is the stimulation wavelength, expressed in nm, and wherein 350 nm<λₓ<500 nm.

18. System according to claim 1, wherein after superposing digitized images, said image is sent to a user.
